(19) United States
(12) Patent Application Publication
(10) Pub. No.: US 2007/0247591 A1
(43) Pub. Date: Oct. 25, 2007

(54) DIGITAL LIGHT PROCESSING PROJECTION APPARATUS

(75) Inventors: Jyh-Horng Shyu, Hsinchu (TW); Chia-Chen Liao, Hsinchu (TW); Chu-Ming Cheng, Hsinchu (TW); Huang-Ming Chen, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: YOUNG OPTICS INC., Hsinchu (TW)

(21) Appl. No.: 11/457,820

(22) Filed: Jul. 17, 2006

(30) Foreign Application Priority Data
Apr. 24, 2006 (TW) 95114512

(51) Int. Cl. G03B 21/00

(52) U.S. Cl. 353/33

(57) ABSTRACT

A digital light processing (DLP) projection apparatus including an illumination system, a digital micro-mirror device (DMD) and an imaging system is provided. The DMD having a common plane and micro mirrors disposed on the common plane is disposed on a transmission path of the illumination beam to convert an illumination beam from the illumination system into an imaging beam into a screen. The imaging system includes a projection lens disposed on a transmission path of the imaging beam and a total internal reflection (TIR) prism disposed between the DMD and the projection lens. The projection lens has an optical axis, which is not parallel to a normal vector of the common plane and a chief beam of the imaging beam. At least one of the normal vectors of the surfaces of the TIR prism opposite to the projection lens and the DMD is not parallel to the optical axis.

### CROSS-REFERENCE TO RELATED APPLICATION

This application claims the priority benefit of Taiwan application serial no. 95114512, filed on Apr. 24, 2006. All disclosure of the Taiwan application is incorporated herein by reference.

### BACKGROUND OF THE INVENTION

1. Field of the Invention

The present invention relates to a projection apparatus, and more particularly, to a digital light processing (DLP) projection apparatus.

2. Description of Related Art

Referring to FIG. 1, a conventional digital light processing (DLP) projection apparatus 100 includes an illumination system 110, a digital micro-mirror device (DMD) 120 and a projection lens 130. The illumination system 110 has a light source 112, which is suitable for providing an illumination beam 114. The DMD 120 disposed on the transmission path of the illumination beam 114 is suitable for converting the illumination beam 114 into an imaging beam 122. The projection lens 130 is disposed on the transmission path of the imaging beam 122 to project the imaging beam 122 onto a screen (not shown), thus forming an image on the screen.

Referring to FIGS. 1 and 2, the DMD 120 has a plurality of micro mirrors 124 (only one is shown in FIG. 2). Each of the micro mirrors 124 is suitable for tilting between angles of ±12 degrees. When one of the micro mirrors 124 rotates with the angle of +12 degrees (i.e., in an ON state), the illumination beam 114 is reflected to a pupil 132 of the projection lens 130. The beam reflected to the pupil 132 is the imaging beam 122. When one of the micro mirrors 124 does not rotate (i.e., in a FLAT state) or rotates with the angle of −12 degrees (i.e., in an OFF state), the beams 122b, 122c reflected by one of the micro mirrors 124 deviate from the pupil 132 of the projection lens 130. The edge portion of the beam 122b reflected by one of the micro mirrors 124 in the FLAT state is tend to enter the pupil 132 of the projection lens 130 to cause a decrease in contrast of the image projected on the screen by the projection lens 130.

Referring to FIG. 3, in order to improve the contrast of the image projected on the screen, an angle of the illumination beam 114 incident to the DMD 120 in the conventional DLP projection apparatus 100 is increased to make an inclined angle between a chief beam of the illumination beam 114 and a chief beam of the imaging beam 122 change from 24 degrees (as shown in FIG. 2) to 26.5 degrees. Thus, it is avoided that the beam 122b reflected by one of the micro mirrors 124 in FLAT state enters the pupil 132 of the projection lens 130 to increase the contrast of the image.

FIG. 4 is a schematic view showing an image 50 projected by a conventional DLP projection apparatus 100 in FIG. 3. FIG. 5A is a data diagram showing modulation transfer function (MTF) measured at position A and position B of the conventional DLP projection apparatus in FIG. 4. FIG. 5B is a data diagram showing MTF measured at position C and position D of the conventional DLP projection apparatus in FIG. 4. Referring to FIGS. 3, 4, 5A and 5B, an axis of abscissas in FIG. 5A or 5B shows a focus shift in units of millimeter, and an axis of ordinates in FIG. 5A or 5B shows is the MTF. It is noted in FIGS. 5A and 5B that since the chief beam of the imaging beam 122 is not parallel to an optical axis X1 of the projection lens 130, thus resolutions of left and right sides of the image 50 projected by the conventional DLP projection apparatus 100 are not symmetrical.

### SUMMARY OF THE INVENTION

An objective of the present invention is to provide a digital light processing (DLP) projection apparatus that considers both the contrast of an image and the symmetry of the resolutions of the image.

Another objective of the present invention is to provide a DLP projection apparatus to improve the symmetry the resolutions of the image.

In order to achieve the aforementioned objectives or other objectives, a DLP projection apparatus suitable for projecting an imaging beam onto a screen is provided by the present invention. The DLP projection apparatus includes an illumination system, a digital micro-mirror device (DMD) and an imaging system. The illumination system is suitable for providing an illumination beam. The DMD having a common plane and a plurality of micro mirrors disposed on the common plane is disposed on a transmission path of the illumination beam. The micro mirrors are suitable for converting an illumination beam into an imaging beam. The imaging system includes a projection lens disposed on a transmission path of the imaging beam to project the imaging beam onto the screen and a total internal reflection (TIR) prism disposed between the DMD and the projection lens. The projection lens has an optical axis, which is not parallel to the normal vector of the common plane and a chief beam of the imaging beam. At least one of the normal vectors of the surfaces of the TIR prism opposite to the projection lens and the DMD is not parallel to the optical axis.

In order to achieve the aforementioned or other objectives, the present invention provides another DLP projection apparatus suitable for projecting an imaging beam onto a screen. The DLP projection apparatus includes an illumination system, a DMD and a projection lens. The illumination system is suitable for providing an illumination beam. The DMD having a common plane and a plurality of micro mirrors disposed on the common plane is disposed on the transmission path of the illumination beam. These micro mirrors are suitable for converting the illumination beam into an imaging beam. The imaging system is disposed on the transmission path of the imaging beam to project the imaging beam onto the screen. The imaging system has an optical axis, which is the connecting line of the center of the common plane and the center of the screen. The normal vector of the common plane and the chief beam of the imaging beam are not parallel to the optical axis. The imaging system has a surface opposite to the DMD, and a normal vector of the surface is not parallel to the optical axis.

The present invention changes the disposed angle of the DMD to alleviate the asymmetry problem of the resolutions of left and right sides of the image projected by the DLP projection apparatus. Moreover, one of the normal vectors of the surfaces of the TIR prism opposite to the DMD and the projection lens is not parallel to the optical axis of the projection lens, thus the optical path difference between the imaging beams resulting from the deviation of the DMD is compensated, and the image projected by the DLP projection apparatus is clear.

In order to the make aforementioned and other objectives, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a conventional DLP projection apparatus.

FIG. 2 is an imaging schematic view of a conventional DLP projection apparatus.

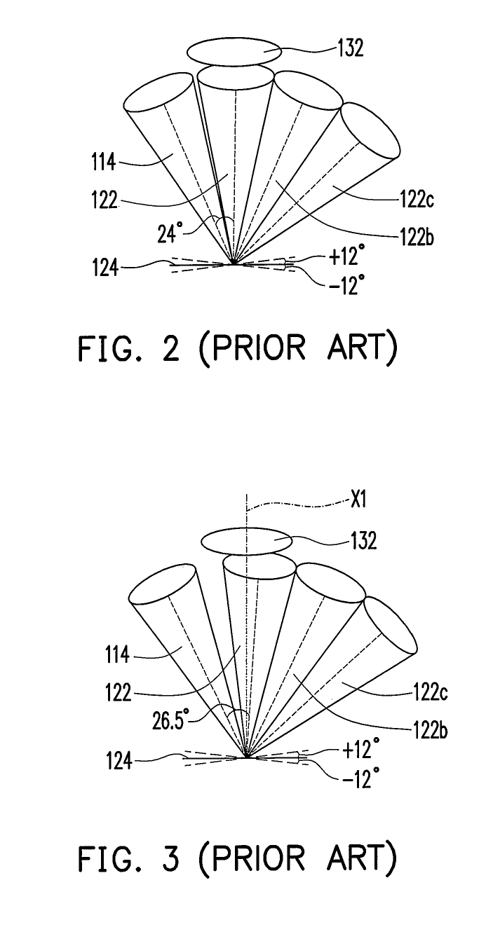

FIG. 3 is an imaging schematic view of another conventional DLP projection apparatus.

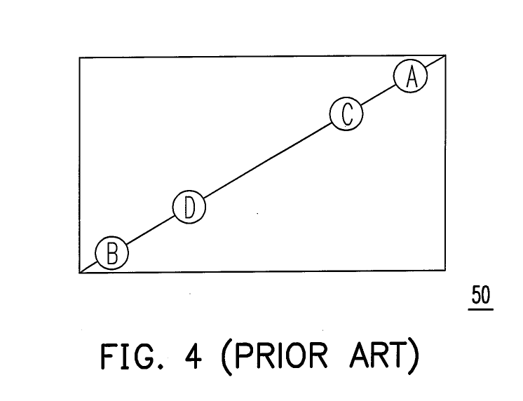

FIG. 4 is a schematic view showing an image projected by the DLP projection apparatus in FIG. 3.

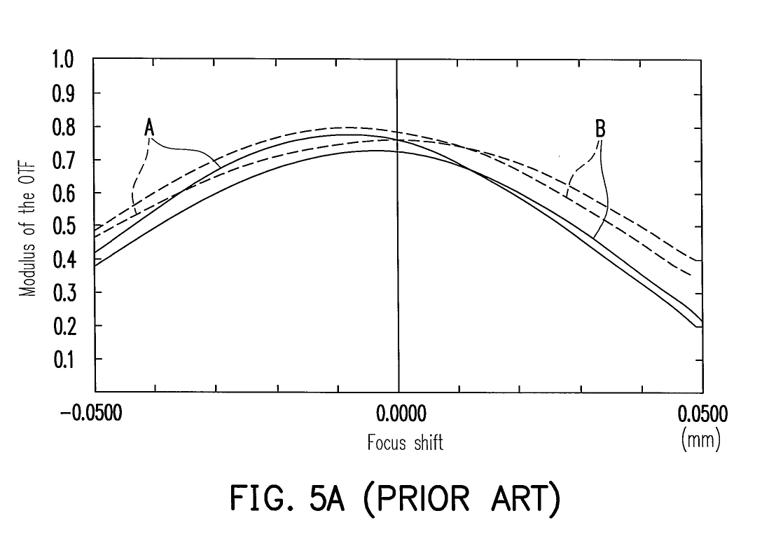

FIG. 5A is a data diagram showing modulation transfer function (MTF) measured at position A and position B of the conventional DLP projection apparatus in FIG. 4.

FIG. 5B is a data diagram showing MTF measured at position C and position D of the conventional DLP projection apparatus in FIG. 4.

FIG. 6 is a schematic view of a DLP projection apparatus according to an embodiment of the present invention.

FIG. 7 is an imaging schematic view of the DLP projection apparatus in FIG. 6.

FIGS. 8A to 8C are respectively the data diagrams showing the astigmatism field curves, the distortion and the lateral color to positions of the image projected by the DLP projection apparatus in FIG. 6 according to the present invention.

FIG. 9 is a diagram showing the recognizability of the DLP projection apparatus in FIG. 6 according to the present invention.

FIG. 10 is a schematic view of an image projected by the DLP projection apparatus in FIG. 6 according to the present invention.

FIG. 11 is a data diagram showing MTF measured from position E to position F of the image in FIG. 10 according to the present invention.

FIG. 12 is a data diagram showing relative illuminations measured from position E to position F of the image in FIG. 10 according to the present invention.

FIG. 13A is a data diagram showing MTF measured at position A and position B of the image in FIG. 10 according to the present invention.

FIG. 13B is a data diagram showing MTF measured at position C and position D of the image in FIG. 10 according to the present invention.

### DESCRIPTION OF EMBODIMENTS

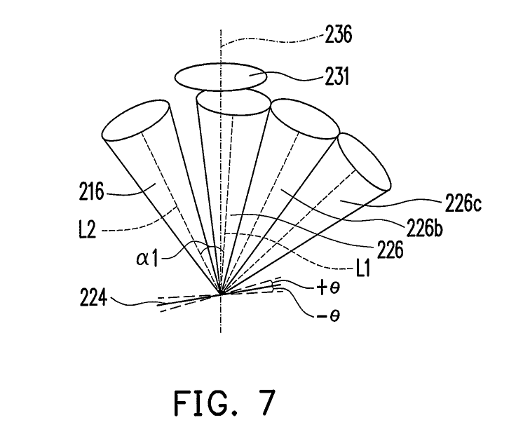

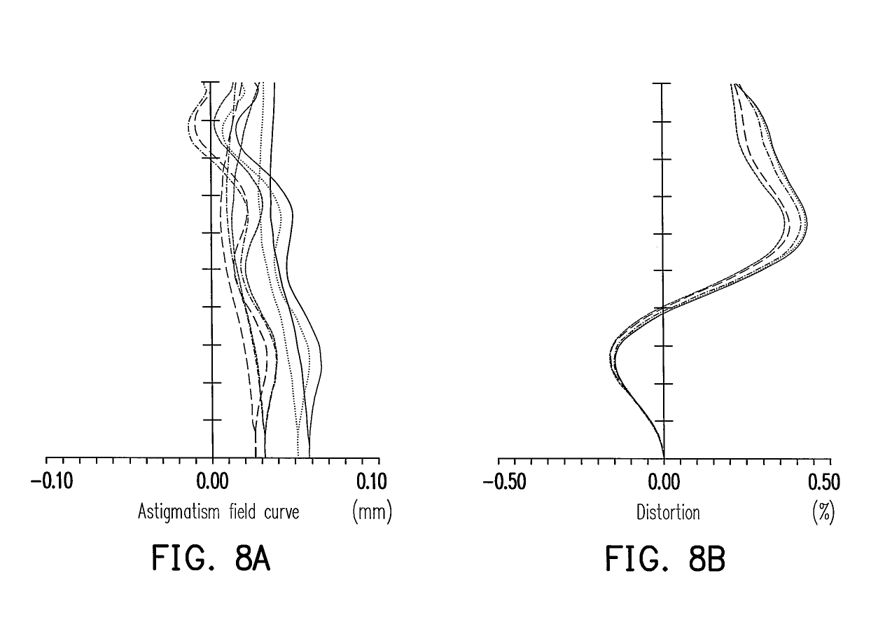

Referring to FIGS. 6 and 7, a DLP projection apparatus 200 of an embodiment according to the present invention includes an illumination system 210, a DMD 220 and an imaging system 230. The illumination system 210 includes a light source 212 and a lens 214. The light source 212 is suitable for providing an illumination beam 216 (FIG. 6 only shows a chief beam of the illumination beam 216). The lens 214 is disposed between the light source 212 and the DMD 220, and is located on a transmission path of the illumination beam 216. In addition, the DMD 220 has a common plane 222 and a plurality of micro mirrors 224 (only one is shown in FIG. 7) disposed on the common plane 222. The DMD 220 is disposed on the transmission path of the illumination beam 216. The micro mirrors 224 are suitable for converting the illumination beam 216 into an imaging beam 226 (FIG. 6 only shows a chief beam L1 of the imaging beam 226).

The imaging system 230 includes a projection lens 232 and a TIR prism 234 disposed between the DMD 220 and the projection lens 232. The projection lens 232 and the TIR prism 234 are disposed on a transmission path of the imaging beam 226 to project the imaging beam 226 onto a screen (not shown). The imaging system 230 has an optical axis, which is a connecting line of a center of the common plane 222 and a center of the screen (not shown). In the embodiment, an optical axis 236 of the projection lens 232 is parallel to an optical axis of the imaging system 230. A normal vector N1 of the common plane 222 of the DMD 220 and the chief beam L1 of the imaging beam 226 are not parallel to the optical axis 236. Moreover, at least one plane of the normal vectors of a surface 234a opposite to the projection lens 232 and a surface 234b opposite to the DMD 220 of the TIR prism 234 is not parallel to the optical axis 236. In FIG. 6, a normal vector N2 of the surface 234b opposite to the DMD 220 of the TIR prism 234 is not parallel to the optical axis 236.

In the above DLP projection apparatus 200, the projection lens 232 includes a plurality of lenses 232a, and a connecting line of central points of the lenses 232a is the optical axis 236. Moreover, one of the micro mirrors 224 is suitable for tilting between angles of ±θ degrees. When one of the micro mirrors 224 tilts in an angle of +θ degrees (i.e., in an ON state), the illumination beam 216 is reflected to a pupil 231 of the projection lens 230 to project the imaging beam 226 to the projection lens 232. When one of the micro mirrors 224 do not tilt (i.e., in a FLAT state) or tilts in an angle of −θ degrees (i.e., in an OFF state), the beams 226b, 226c reflected by one of the micro mirror 224 deviate from the pupil 231 of the projection lens 230.

Referring to FIG. 7, it is notable that in the embodiment, an inclined angle α1 between the chief beam L2 of the illumination beam 216 incident to the DMD 220 and the chief beam L1 of the imaging beam 226 is larger than 2θ, so as to prevent the beam 226b from entering the pupil 231 of the projection lens 230. Thus, the DLP projection apparatus 200 of the embodiment projects an image with high contrast. Moreover, the above θ is, for example, 12 degrees, and α1 is, for example, 26.5 degrees.

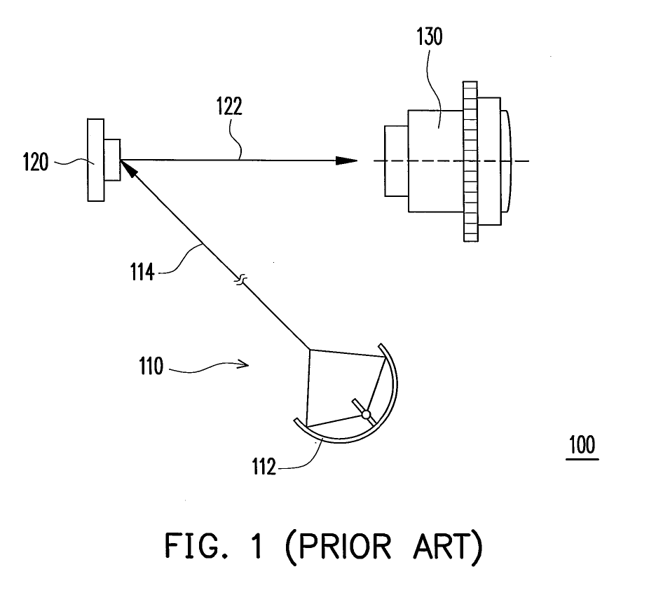

In order to improve the asymmetry problem of the resolutions of left and right sides of the image projected by the conventional projection apparatus 100 in FIG. 1, in the embodiment, the tilting angle of the DMD 220 is particularly changed to make an angle between the normal vector N1 of the common plane 222 of the DMD 220 and the optical axis 236 of the projection lens 232 be an acute angle α2, and α2≧0.1 degree, whereby resolutions of left and right sides of the image projected by the DLP projection apparatus 200 are relatively more symmetric than the resolutions of the image projected by the conventional projection apparatus 100 in FIG. 1. In a preferred embodiment, α2 is, for example, between 0.2 degrees and 0.4 degrees.

As described above, since the change of the disposed angle of the DMD 220 makes a focus position projected on a screen focal plane of the imaging beam 226 deviate along with it, the image projected on the screen by the DLP projection apparatus 200 is not clear. According to Scheimpflug principle, only when an intersection of an extension plane of the common plane 222 of the DMD 220 and an extension plane of the screen is on an extension plane of a principle plane of the imaging system 230, the image projected on the screen is clear. Therefore, in the embodiment, the normal vector N2 of the surface 234b of the TIR prism 234 is particularly not parallel to the optical axis 236 of the projection lens 232, thereby the principle plane of the imaging system 230 is changed, and thus making the intersection of the extension plane of the common plane 222 of the DMD 220 and the extension plane of the screen on the extension plane of the principle plane of the imaging system 230.

Moreover, since the disposed angle of the DMD 220 is changed, if the surface opposite to the DMD 220 of the TIR prism 234 is a surface 234c, i.e., the normal vector of the surface opposite to the DMD 220 of the TIR prism 234 is still parallel to the optical axis 236 of the projection lens 232, distances between each point on the common surface 222 of the DMD 220 and the surface 234c of the TIR prism 234 is different. Thus, an optical path difference occurs between each of beams reflected by one of micro mirrors 224 in an ON state. Therefore, the problem of the optical path difference is alleviated by making the normal vector N2 of the surface 234b of the TIR prism 234 be not parallel to the optical axis 236 of the projection lens 232, thus improving an imaging quality of the DLP projection apparatus 200.

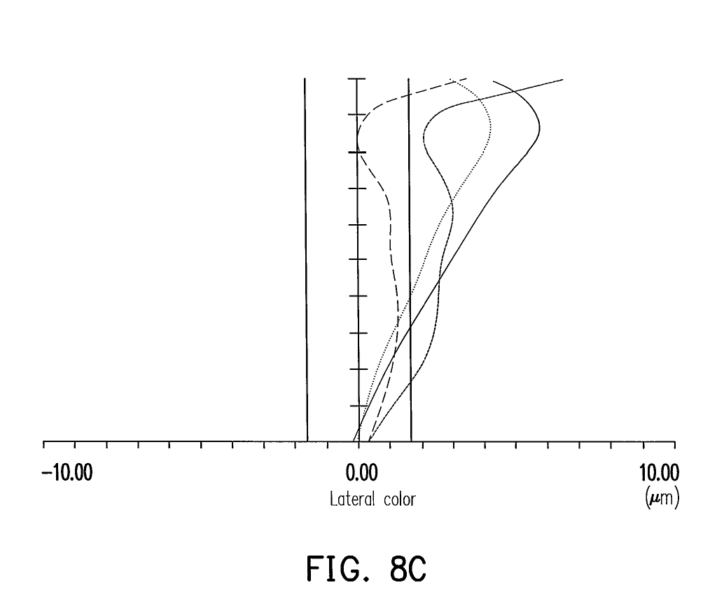

FIGS. 8A to 8C are respectively the data diagrams showing the astigmatism field curves, the distortion and the lateral color to positions of the image projected by the DLP projection apparatus in FIG. 6 according to the present invention. Referring to FIGS. 8A to 8C, since the diagrams of the astigmatism field curves, the distortion or the lateral color are all in the range of the criteria, the DLP projection apparatus 200 of the embodiment has a good imaging quality.

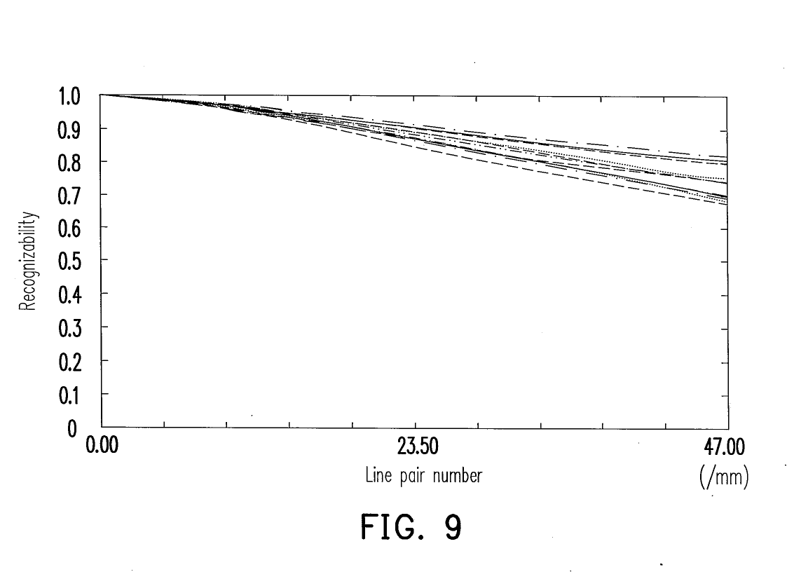

FIG. 9 is a diagram showing recognizability of the DLP projection apparatus in FIG. 6 according to the present invention. In FIG. 9, the transverse axis represents the number of the line pairs that is shown in a distance of 1 millimeter, and the longitudinal axis represents the recognizability of the line pair number. It is noted in FIG. 9 that even though the line pair number has reached 47 mm, the recognizability thereof is still above 0.7. Therefore, in the embodiment, the diagram between the recognizability and the line pair number is still conformed to the specification of the criterion when the tilting angle of DMD 220 is changed to make the normal vector N2 of the surface 234b of the TIR prism 234 be not parallel to the optical axis 236 of the projection lens 232.

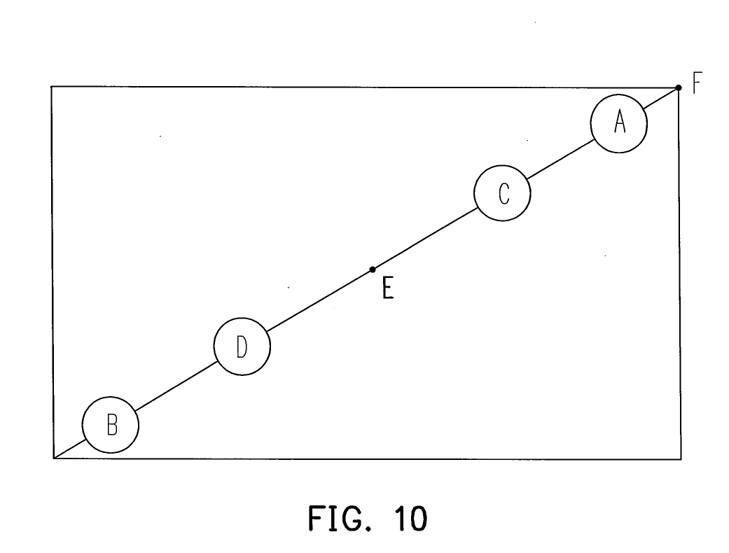

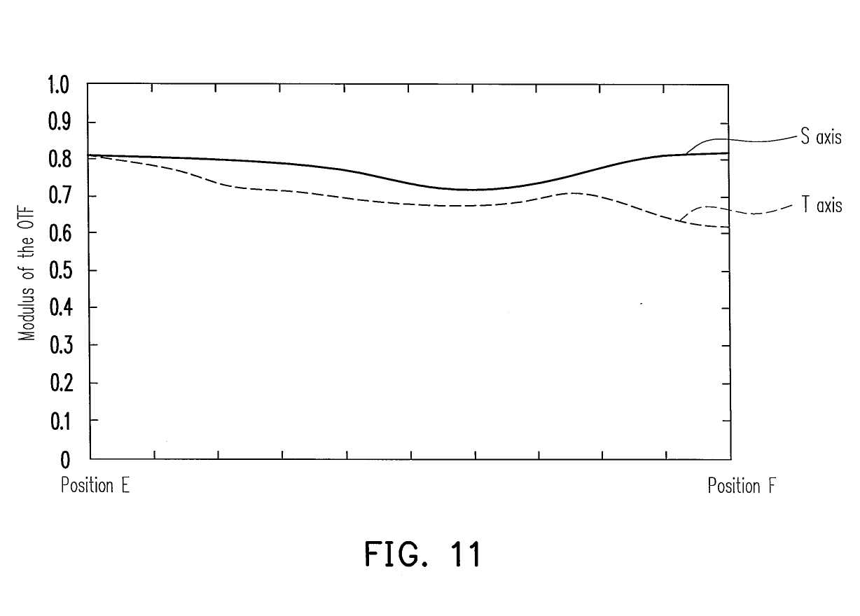

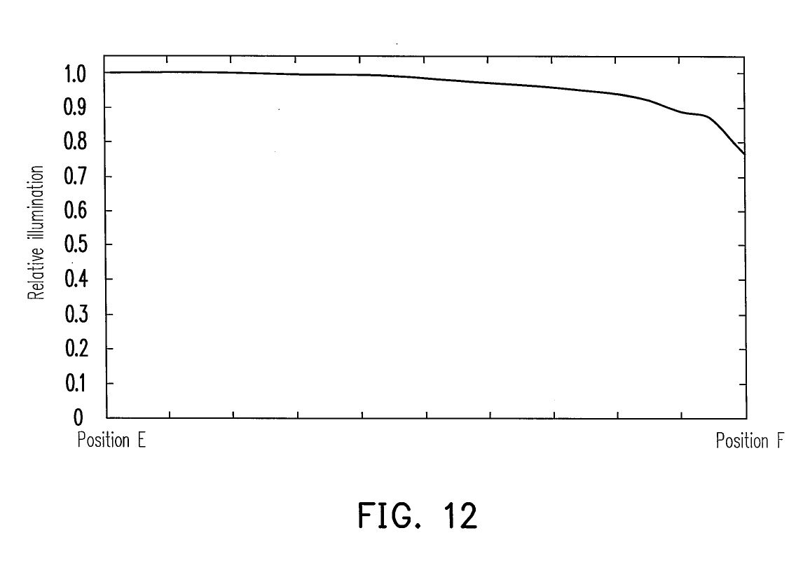

FIG. 10 is a schematic view of an image projected by the DLP projection apparatus in FIG. 6 according to the present invention. FIG. 11 is a data diagram showing MTF measured from position E to position F of the image in FIG. 10 according to the present invention. FIG. 12 is a data diagram showing relative illuminations measured from position E to position F of the image in FIG. 10 according to the present invention. Referring to FIGS. 11 and 12, it is noted in FIG. 11 that the MTF of S axis and T axis measured from position E to position F is in the range of the criterion. Moreover, FIG. 12 shows that a uniformity corresponding to the relative illuminations measured from position E to position F of the image in the FIG. 10 is also conformed to the criterion.

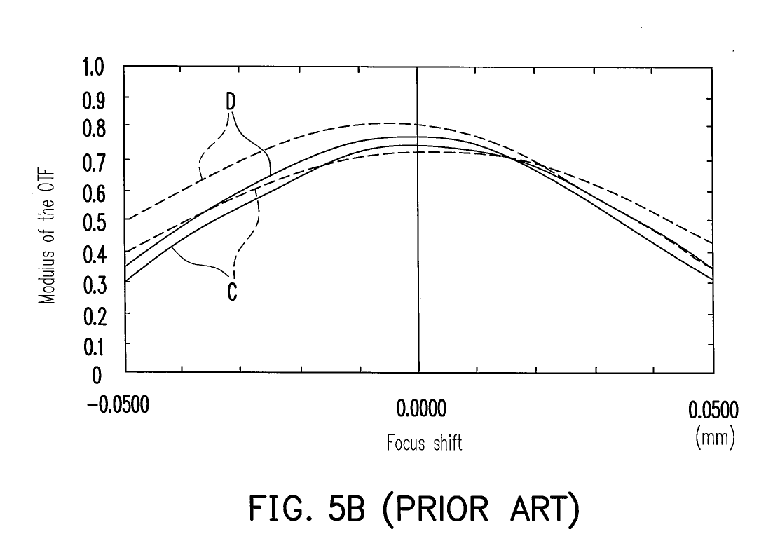

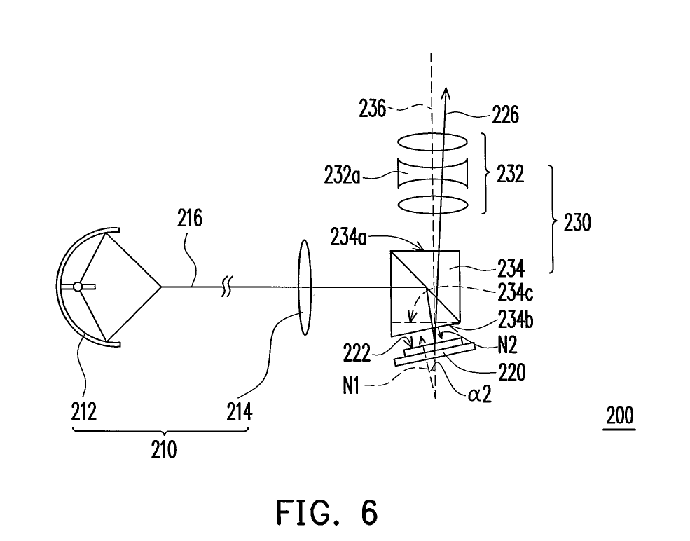

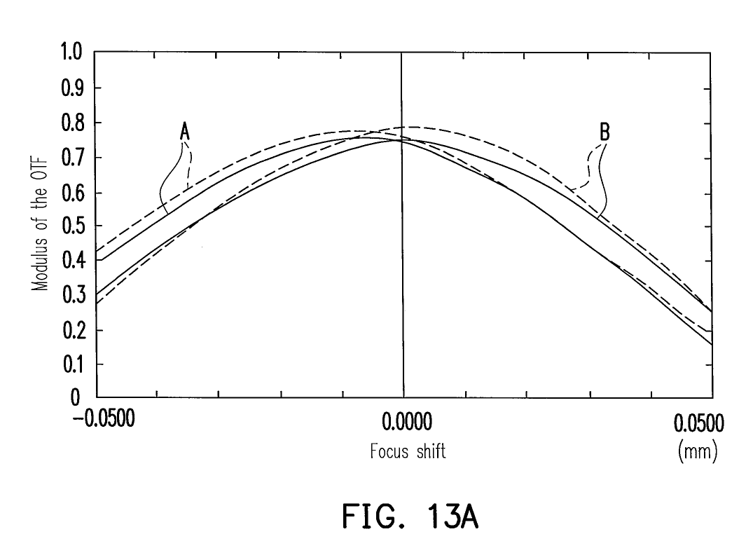

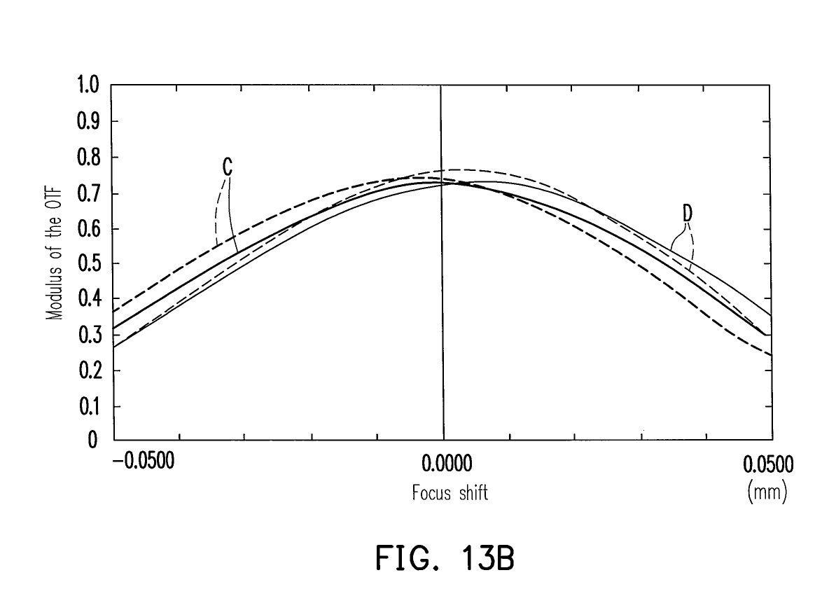

FIG. 13A is a data diagram showing MTF measured at position A and position B of the image in FIG. 10 according to the present invention. FIG. 13B is a data diagram showing MTF measured at position C and position D of the image in FIG. 10 according to the present invention. Referring to FIGS. 5A, 5D, 13A and 13B, it is noted in comparisons of FIG. 5A and FIG. 13A, and comparisons of FIG. 5B and FIG. 13B that the resolutions of left and right sides of the image projected by the DLP projection apparatus 200 of the embodiment are more relative symmetrical than the resolutions of the image projected by the conventional DLP projection apparatus 100 in FIG. 1.

Although, in the above embodiment, the asymmetry problem of the resolutions of left and right sides of the image is alleviated by making a normal vector of the surface 234a or 234b of the TIR prism 234 not parallel to the optical axis 236 of the projection lens 232, however, the present invention improves the symmetry of the resolutions of left and right sides of the image by making at least one of the normal vectors of the surfaces of the lenses 232a opposite to the DMD 220 in the imaging system 230 be not parallel to the optical axis 236 of the imaging system 230. In other words, in the present invention, the asymmetry problem of the resolutions of left and right sides of the image is alleviated by making the normal vector of the surface of at least one lens 232a of the projection lens 232 be not parallel to the optical axis 236 of the imaging system 230, thus improving the imaging quality of the DLP projection apparatus 200.

To sum up, the present invention changes the disposed angle of the DMD to make the normal vector of the common plane of the DMD be not parallel to the optical axis of the projection lens, so as to alleviate the asymmetry problem of the resolutions of left and right sides of the image projected by the conventional DLP projection apparatus. Therefore, the DLP projection apparatus of the present invention considers both the contrast of the image and the symmetry of the resolutions of left and right sides of the image. Moreover, with one of the normal vectors of the surfaces of the lenses opposite to the DMD and the projection lens of the TIR prism being not parallel to the optical axis of the projection lens, the optical path difference between the imaging beams resulting from the deviation of the DMD is compensated, and the image projected by the DLP projection apparatus is clear.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A digital light processing (DLP) projection apparatus, comprising:
an illumination system, suitable for providing an illumination beam;
a digital micro-mirror device (DMD), disposed on a transmission path of the illumination beam, wherein the DMD has a common plane and a plurality of micro mirrors disposed on the common plane, and the micro mirrors are suitable for converting the illumination beam into the imaging beam; and
an imaging system, comprising:
a projection lens, disposed on the transmission path of the imaging beam to project the imaging beam onto a screen, wherein the projection lens has an optical axis, and a normal vector of the common plane and a chief beam of the imaging beam are not parallel to the optical axis; and
a total internal reflection (TIR) prism, disposed between the DMD and the projection lens, wherein at least one of the normal vectors of the surfaces of the TIR prism opposite to the projection lens and the DMD is not parallel to the optical axis.

2. The DLP projection apparatus as claimed in claim 1, wherein the micro mirrors are suitable for tilting between angles of ±θ degrees, and an inclined angle between a chief beam of the illumination beam incident to the DMD and the chief beam of the imaging beam is larger than 2θ.

3. The DLP projection apparatus as claimed in claim 1, wherein an acute angle between the normal vector of the common plane and the optical axis of the imaging system is α, and α≧0.1 degree.

4. The DLP projection apparatus as claimed in claim 3, wherein 0.2 degree≦α≦0.4 degree.

5. The DLP projection apparatus as claimed in claim 1, wherein the imaging system has a principle plane, and an intersection of an extension plane of the common plane of the DMD and an extension plane of the screen is on an extension plane of the principle plane.

6. The DLP projection apparatus as claimed in claim 1, wherein the projection lens comprises a plurality of lenses, and a connecting line of central points of the lenses is the optical axis.

7. The DLP projection apparatus as claimed in claim 1, wherein the illumination system comprises:
a light source, suitable for providing the illumination beam; and
a lens, disposed between the light source and the DMD and located on the transmission path of the illumination beam.

8. A digital light processing (DLP) projection apparatus, comprising:
an illumination system, suitable for providing an illumination beam;
a digital micro-mirror device (DMD), disposed on a transmission path of the illumination beam, wherein the DMD has a common plane and a plurality of micro mirrors disposed on the common plane, and the micro mirrors are suitable for converting the illumination beam into an imaging beam; and
an imaging system, disposed on the transmission path of the imaging beam to project the imaging beam onto a screen, wherein the imaging system has an optical axis defined as a connecting line of a center of the common plane and a center of the screen, and a normal vector of the common plane and a chief beam of the imaging beam are not parallel to the optical axis, and the imaging system has a surface opposite to the DMD, and a normal vector of the surface is not parallel to the optical axis.

9. The DLP projection apparatus as claimed in claim 8, wherein the micro mirrors are suitable for tilting between angles of ±θ degrees, and an inclined angle between a chief beam of the illumination beam incident to the DMD and the chief beam of the imaging beam is larger than 2θ.

10. The DLP projection apparatus as claimed in claim 8, wherein an acute angle between the normal vector of the common plane and the optical axis of the imaging system is α, and α≧0.1 degree.

11. The DLP projection apparatus as claimed in claim 10, wherein 0.2 degree≦α≦0.4 degree.
